(19) United States
(12) Patent Application Publication
(10) Pub. No.: US 2006/0015845 A1
(43) Pub. Date: Jan. 19, 2006

(54) Method and system for managing measurement operations of testing and analysis devices

(76) Inventor: Mark Tomchin, Bat Yam (IL)

Correspondence Address: KATTEN MUCHIN ROSENMAN LLP, 575 MADISON AVENUE, NEW YORK, NY, 10022-2585, US

(21) Appl. No.: 10/889,744

(22) Filed: Jul. 13, 2004

(51) Int. Cl. G06F 9/44

(52) U.S. Cl. 717/109

(57) ABSTRACT

The present invention provides a system for automatically generating software code for managing multitasking operations of testing and analysis devices. The system is comprised of: computerized control device for controlling the operation of testing and analysis devices, set of software simulation modules, each module imitating the panel control of respective testing and analysis device wherein the user is enabled to operate said device simulation using the computerized device interface (keyboard) and an automatic programming application for creating software code according to user instructions as conveyed through the simulation operation.

### BACKGROUND OF THE INVENTION

The present invention relates to the field of automated testing and analysis systems, and more precisely, to the field of automating testing and analysis devices using a graphic user interface which simulate the devices' interface.

Computer-based systems, which automate testing procedures, are well known in the art. These systems monitor and automate the operation of laboratory devices, allowing the user to control the procedure via a user interface (UI), and collect measurement data from the devices. These systems use the information given by the user to generate software code which enable a computer to operate a device. The user can then determine the device's mode of operation, set parameter values, repeat procedures with exact precision and computerize the recording of the device's output.

Also known in the art wizard-like computer software, which enable the coordinate operation of several testing and analysis devices, using a graphic user interface (GUI). Such systems monitor and automate the operation of laboratory devices, coordinate synchronized procedures combining a wide variety of testing instruments and enable meticulous repetition of these procedures. These systems help conduct and keep track of results of testing and experimental procedures. A system of this kind is described, for example, in U.S. patent application No. 20030001896. This is a GUI system which stores the parameter values entered by the user, analyzes them, and generates the measurement task specification (MTS) in response to this analysis. The MTS is then useable to produce a computer's code program which implements the measurement task repeatedly.

Although system of this sort facilitate conducting laboratory tasks which involve multiple devices, and increase the efficiency of working procedures and of recording analysis findings, they do have their shortcoming. Their major drawback is that although they are equipped with user-friendly GUI, these are complex systems and managing them still demands significant computer operating skills. The implementation of a new system, than, requires on the part of the laboratory personnel extensive learning of its particular mode of operation, learning which becomes redundant once the system is upgraded or replaced.

There is therefore a need for a computer-based testing and analysis automating system equipped with a GUI that operates according to principles that is consistent with the skills of the laboratory personnel, and demand minimal adjusting efforts.

### SUMMERY OF THE INVENTION

The present invention provides a system for automatically generating software code for managing multitasking operations of testing and analysis devices. The system is comprised of: computerized control device for controlling the operation of testing and analysis devices, set of software simulation module each module imitating the panel control of respective testing and analysis device wherein the user is enabled to operate said device simulation using the computerized device interface (keyboard) and an automatic programming application for creating software code according to user instructions as conveyed through the simulation operation.

The software code creation represent sequence of tasks wherein each task include user instruction for operating a single device. According to a further feature of the invention the system includes a GUI application which enable the user to add logical instruction for operating the device not included in device control panel option.

The system additionally comprises a graphic application providing the user with illustration of the created program code logic operation flow.

For more advanced users the system further comprise a programming interface and converter enabling the user edit the program logic through graphical GUI or alternatively a programming interface and converter enabling the user edit the program logic through known compiler interface.

### BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein—

FIG. 1 is a schematic description of the system.

FIG. 2 displays the main screen of the preferred embodiment of the invention.

FIG. 3 displays the runtime screen of the preferred embodiment of the invention.

FIG. 4 displays the report builder of the preferred embodiment of the invention.

FIG. 5 displays the Regime Menu of the preferred embodiment of the invention.

FIG. 6 displays the Steps Type Menu of the preferred embodiment of the invention.

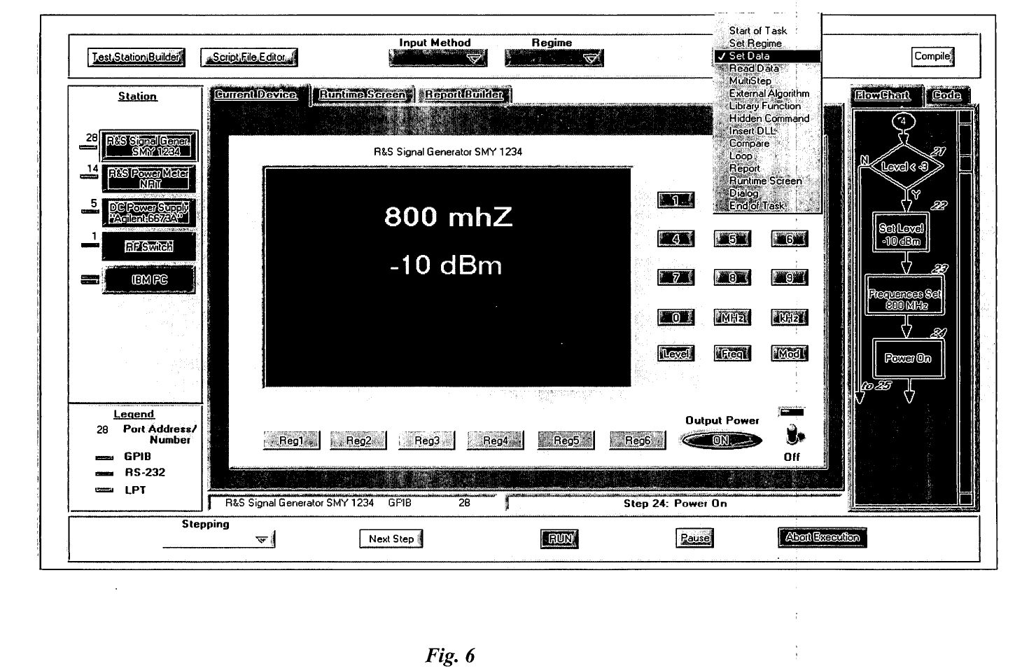

FIG. 7 displays the Stepping Menu of the preferred embodiment of the invention.

FIG. 8 displays the flowchart elements.

### DETAILED DESCRIPTION OF THE PREFERRED EMBODIMENT

The present invention is a system and method for automatically generating software facilities for managing testing and analysis devices, implementing a new approach in its graphic user interface. The invention's interface simulates the real-world interface of laboratory devices, turning it into an extremely user friendly for experienced laboratory personnel. By replicating the manual modes of operating the devices, the system enables the user to effortlessly operate the system so it automatically generates software code, without having to relay on programming skills or on extensive computer operating knowledge.

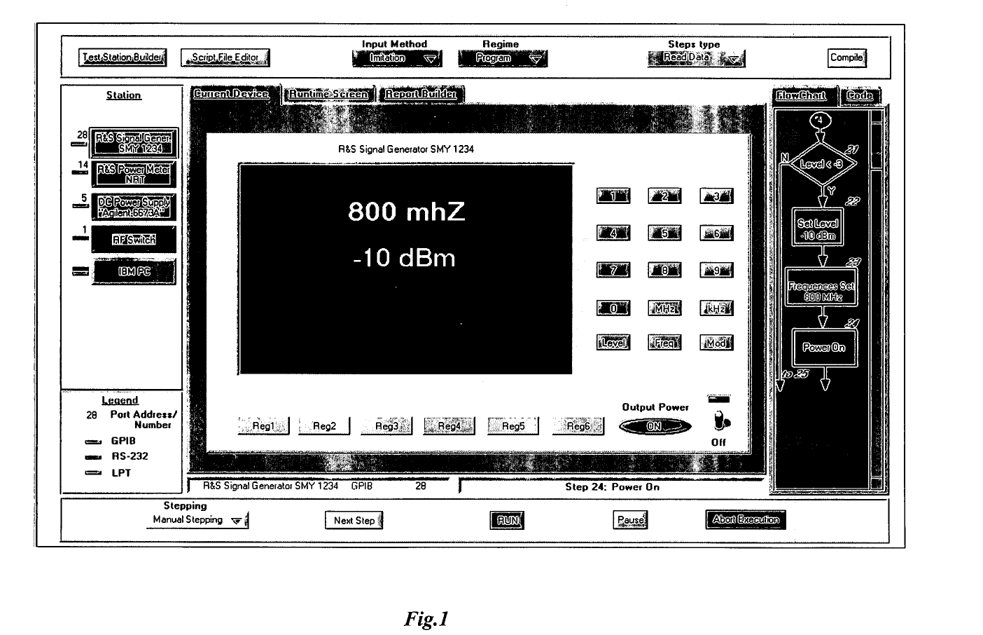

The preferred embodiment of the invention is illustrated in FIG. 1. This embodiment is comprised of a software application installed on a PC computer 1, having an input interface and with connection ports (standard USB, GPIB, RS232 or LPT, for example). Through these ports the computer connects to any number of testing and analysis devices 2, and maintains a bi-directional communication with them. These lines of communication 3 allow the system to establish a connection between the devices 2 and a database on computer 1; operate distant monitoring of devices 2 by computer 1; and activate parallel asynchronous testing and control. Having stored all relevant information from the testing devices 2 into its database, the system can then produce reports displaying information about the devices' 2 operation and their testing and analysis data.

Representation of current information re running algorithm and its intermediate results on the Time Execution Screen, built by the user].

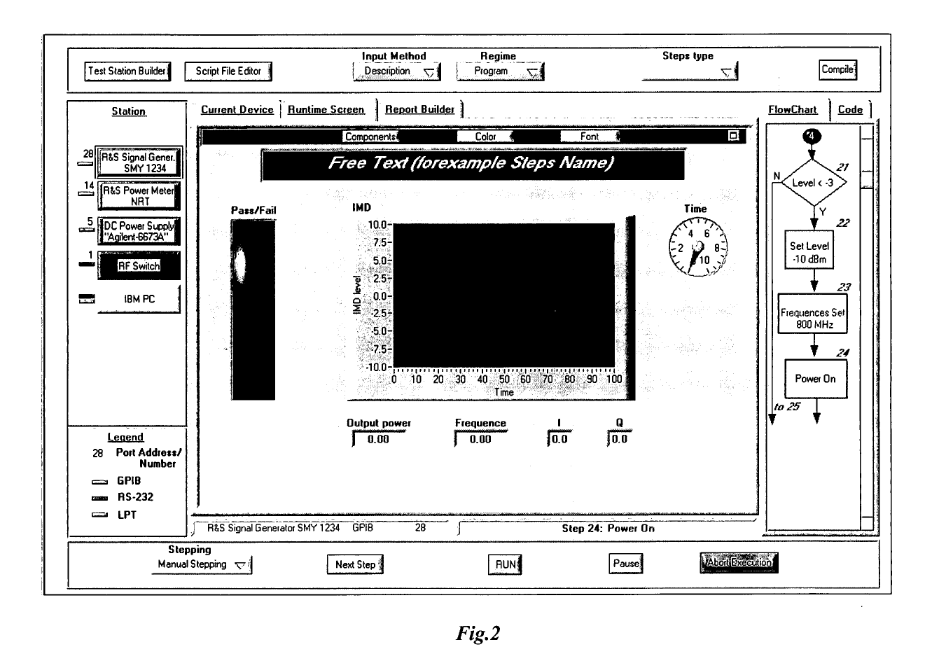

The system is operated through a set of user interface screens that simulate the actual testing and analysis devices' interface. FIG. 2 illustrates an example for such a user interface screen through which the user may operate the system by specifying the desired sequence of operations. Through the system's GUI the user may replicate the manual procedure of operating the devices on to the user interface. The user then specifies additional information such as connectivity with the database, simple and formulated if-then conditions, displaying of current results on the screen and so on, through dialog boxes and menus. Once the full procedure is laid out, the user's instructions are converted into a C++ programming language code, which is generated automatically, compiled and run on computer 1. In order to expand the final product possibilities, DLL algorithm modules may be included in the software, developed by other programming means such as Visual C++, Visual Basic, Borland C++ Builder, Delphi and so on.

The operation of any testing and analysis digitally operated device may be automated by the system. A trained system administrator does this procedure. The system administrator needs only to add the image of the device's panel to the system, and through a built-in wizard the device's structure, its characteristics, [involving facilities allowing the use of resulting program in parallel asynchronous testing mode], form of report presentation, modes of database connectivity and any other required data may be specified.

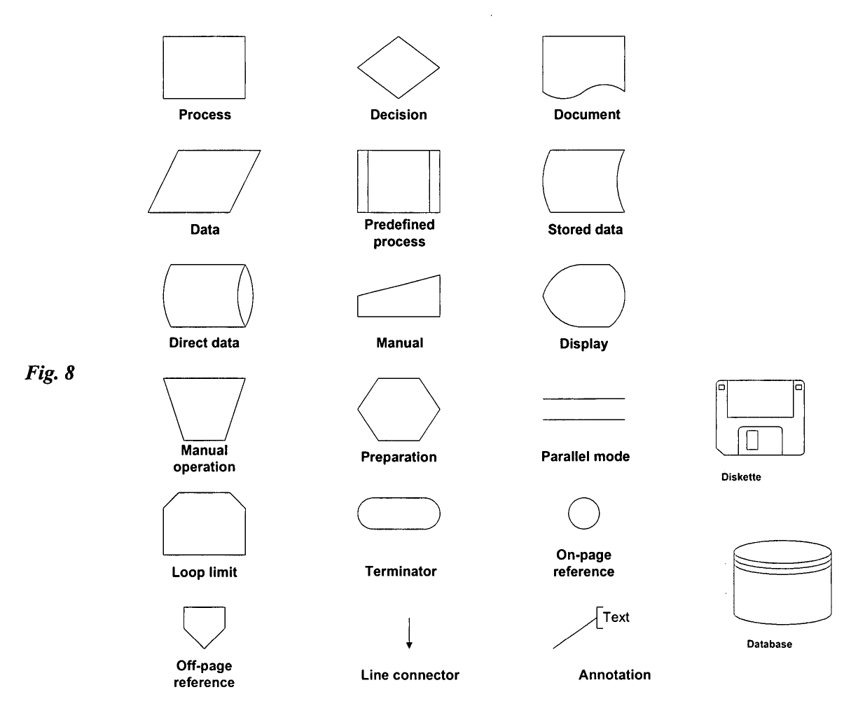

Having defined the relevant devices in the system the procedure of operating it involves the following steps. First, the sequence of operations which need to be executed on the device need to be specified by simulating the manual activation of the devices on the “current device” GUI screen 210, as illustrated in FIG. 2. At this stage the system may work in an operational or in a programming mode. The operational mode is an immediate execution mode where every operation executed on the graphic display is immediately translated to a command to the device. Using this mode can set the device into the appropriate condition and is similar in every way to a direct manual operation of the device. In programming mode, the operations executed by the user are recorded and are later run as part of the procedure of the automated operation of the device. Second, the logical operations of the algorithm are inputted. The logical operations, which help manage the sequence of the automatic execution, may be inserted in Algorithm Window 220. Description of the logical flow of the execution may be portrayed by a flow chart. The flow chart logical operators used are the standard flow chart operators, as described in FIG. 8. In the flow chart the user may also insert formulas which relate to the output data from the devices, in order to determine the desired sequence of events.

To help manage the sequence of operation the user may divide it into tasks, allowing each task to function as an individual algorithm. This option facilitates the management of the automatic procedure and of the testing of the system's operation.

The execution plan may also be converted to C++ programming code. This option allows the user to edit the automatically generated C++ code, and perform changes in a code-editing mode. The code is displayed in the Algorithm Window 220. Choosing either flow chart tab 221 or the code tab 222 performs switching between the flow chart display and the code display in the Algorithm Window 220. During execution, the executed algorithm is highlighted at any given point in time in the Algorithm Window 220, both in flow chart display and in code display.

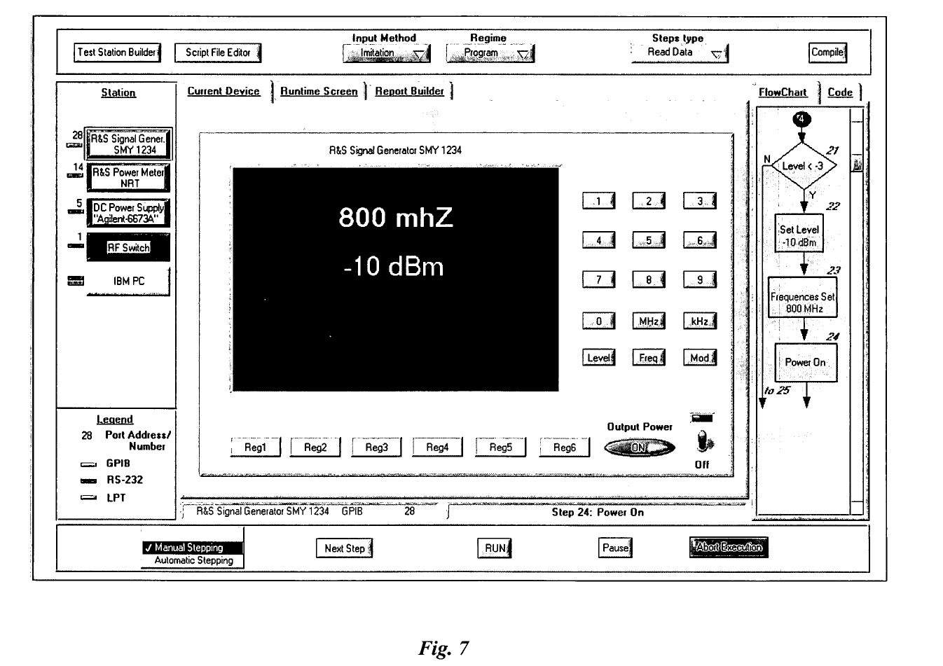

In order to test the sequence of operations the user has two modes of executing it: an automatic and a manual mode through menu 711 as illustrated in FIG. 7. The automatic mode is the normal mode of operation where the user's recorded commands are executed sequentially. The user determines the time interval between the executions of two consecutive steps. In manual mode the recorded commands are run in a step-by-step mode. In this mode the system stops after the execution of each algorithm and waits for the user to press on the Next Step Button 712 before proceeding to the next one.

Having tested the algorithms the user may edit the sequence of execution by adding, rearranging and removing functional blocks of algorithm. This option enables the user to separately test algorithms and then integrate them into a complex sequence of operation. This also allows the usage of predefined algorithms which may be standard or regularly used. Such algorithms will be added to the main execution procedure as external algorithms and may be protected from being changed.

At this point of developing the execution sequence, the DLL application components from other developing environments may be integrated into the system.

Finally, having completed the editing stage, the program may be compiled and is ready to be executed. The execution procedure flow may be controlled by commands given by the user via the Control Panel Window 710 (see FIG. 7). Beside determining between automatic and manual stepping in menu 711 and the Next Step Button 712, as described above, the user may also run the program by clicking on the Run Button 713, pause it by choosing the Pause Button 714 and abort it via the Abort Execution Button 715.

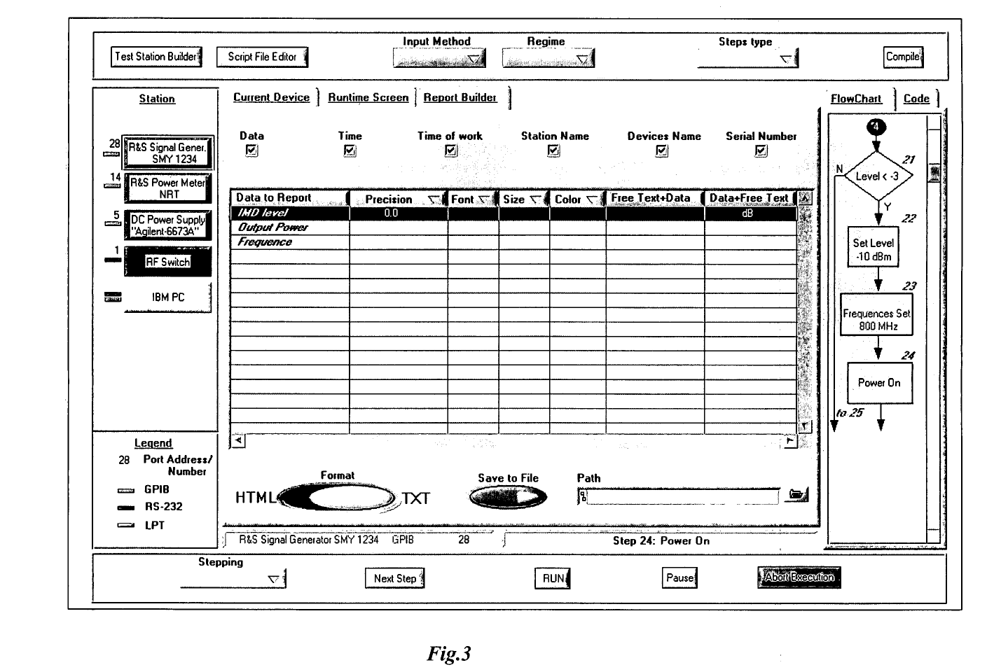

The output data received from the devices may be displayed graphically or in reports. The graphic display of the output appears on the “runtime screen”, as illustrated in FIG. 3. This screen contains the graphic indicators of the devices, such as their display screens 31, clocks 32, counters 33 and any other type of output display.

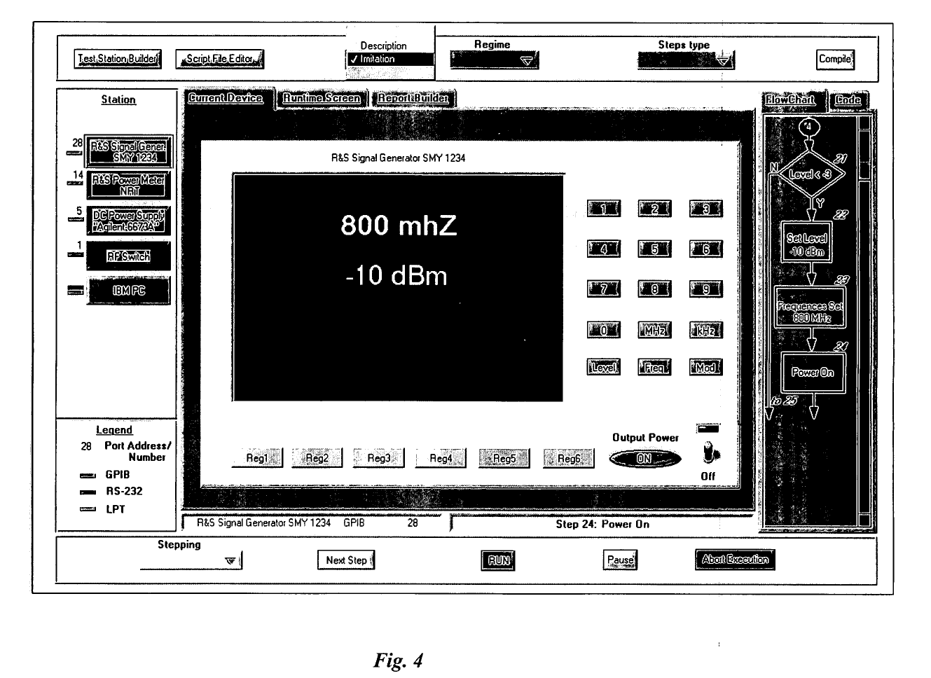

Runtime results may also be displayed in a report format. FIG. 4 illustrates a report-building screen. In this screen the user may select the data 401 that the report should contain and the format in which this data should be displayed. The format features may include the numeric precision 402, font 403, size 404, color 405, 406 and 407. The user may select the desired file type 430 of the report file, such as choosing between HTML and text formats. The title of the report may contain automatically produced data such as the date 431, time 432 and duration of testing 433, name of testing station 434, name of tested devices 435 and their serial number 436.

Activating a report wizard may also generate reports. The report wizard may be prompted via selecting the flow chart's document symbol or by clicking on the report button in the main window. The wizard enables the user to choose the desired information, from lists of available data, and the format of its display.

Additional information which may be displayed onscreen is the Station Configuration Window 230. This window holds information as for the devices which are connected to the system and their communication features such as port type and device address. In this window also gives an indication, which devices are activated at every point in time during the execution of the algorithm.

Besides entering the algorithm, the user can build at this stage Time Execution Screen, which will display all needed data while running the algorithm. This screen has a view of bookmark and replaces bookmark Device (details in chapter “Main Screen of system MEASUREMENT MAGIC”). While projecting this screen the user chooses from activating menu of indicators and dialog boxes the needed ones and places them into field “Time Execution Screen”. Every indicator is arbitrary named, and the name is displayed on the Time Execution Screen. While running the algorithm, Time Execution Screen can be used as Main Screen.

The system may include several maintenance functions which enable a user or a system administrator to test and extend the functionality of the system at any given time. By activating a wizard the configuration of the connection of the devices that are currently connected can be checked. The activation of the said wizard may be done by clicking on Test Station Builder Button 231.

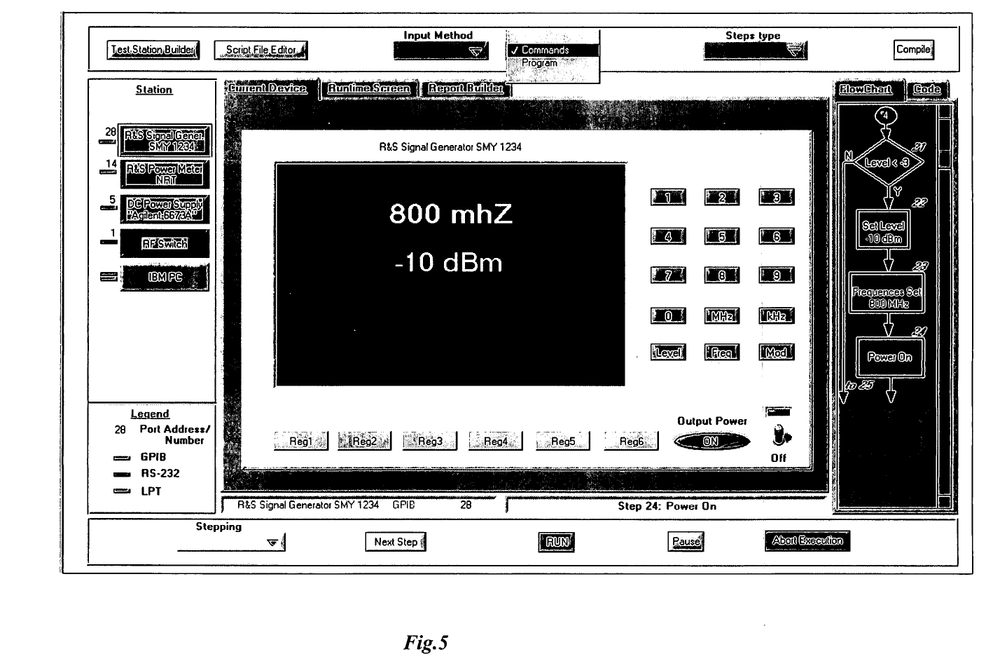

Pop-up menu “Regime” (see FIG. 5) offers a choice of regime in the work with devices, involved into the station—“Program” or “Commands”.

FIG. 5 Menu “Regime”

The preferred embodiment of the invention realizes imitation of work with real instruments, by means of controllers and their informational field screens in script files. Each device has its own corresponding script file. Set of these files makes up a devices library in the system's environment. A script file contains format trees of commands for each device and, in addition, a specification of every tree component. Editing or viewing these trees is possible by means of built in script file editor which may be entered by clicking on the Script File Editor Button 232. As mentioned above, preparing script files for new device is done through a script file wizard. Each operational element on photographic display of the given device is numbered in a semi-automatic procedure and henceforth this number becomes assigned to a corresponding field of command tree. This allows for every graphical object to be used for the emulation of the manual mode, according to the description in the devices' script file. On activating the given object, the system calls an immediate transfer of a command or of a chain of commands. If needed, the script file wizard enables the user to protect the access to script files' information with a password.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A system for automatically generating software code for managing multitasking operations of testing and analysis devices, said system comprised of:
computerized control device for controlling the operation of testing and analysis devices;
set of software simulation modules, each module imitating the panel control of respective testing and analysis device wherein the user is enabled to operate said device simulation using the computerized device interface (keyboard);
an automatic programming application for creating software code according to user instructions as conveyed through the simulation operation.

2. The system according claim 1 wherein software code creation represent sequence of tasks, wherein each task include user instruction for operating a single device.

3. The system according claim 2 further including GUI application enabling user to add logical instruction for operating the device not included in device control panel option.

4. The system according to claim 1 further comprising a graphic application providing the user with illustration of the created program code logic operation flow.

5. The system according claim 4 further comprising programming interface and converter enabling the user to edit the program logic through graphical GUI.

6. The system according claim 5 further comprising programming interface and converter enabling the user to edit the program logic through known compiler interface.
